(19) United States
(12) Patent Application Publication
(10) Pub. No.: US 2020/0212546 A1
(43) Pub. Date: Jul. 2, 2020

(54) WEARABLE ANTENNA DEVICE

(71) Applicants: NEC CORPORATION, Minato-ku (JP); NEC PLATFORMS, LTD., Kawasaki-shi, Kanagawa (JP)

(72) Inventors: Shinichirou KODAMA, Tokyo (JP); Kenji KOUNO, Tokyo (JP); Tomohiro SHIMODA, Kawasaki-shi Kanagawa (JP); Kazuaki MUROFUSHI, Kawasaki-shi, Kanagawa (JP); Hidenori MORIYA, Kawasaki-shi, Kanagawa (JP); Mitsuno KONDO, Kawasaki-shi, Kanagawa (JP); Sumio HIRAKU, Kawasaki-shi, Kanagawa (JP); yUKIO ANDO, Kawasaki-shi, Kanagawa (JP); Tetsuya NAGATA, Kawasaki-shi, Kanagawa (JP)

(73) Assignees: NEC CORPORATION, Tokyo (JP); NEC PLATFORMS, LTD., Kawasaki-shi, Kanagawa (JP)

(21) Appl. No.: 16/608,534

(22) PCT Filed: Apr. 10, 2018
(86) PCT No.: PCT/JP2018/015066

§ 371 Date: Oct. 25, 2019

(30) Foreign Application Priority Data
May 2, 2017 (JP) 2017-091928

(51) Int. Cl. H01Q 1/27; H01Q 1/52; H01Q 17/00; H01Q 15/14; H01Q 1/36

(52) U.S. Cl. CPC H01Q 1/273; H01Q 1/526; H01Q 1/36; H01Q 15/14; H01Q 17/005

(57) ABSTRACT

The wearable antenna device includes an antenna part—attached to a part of a garment including a body accommodation part—that accommodates a part of a body, and a functional element arranged in a position of the garment in such a way that at least a part of the functional element is opposed to the antenna part with the body accommodation part interposed therebetween. The functional element is another antenna part or an element that performs at least one of reflection, shielding, and absorption of radio waves

### TECHNICAL FIELD

The present disclosure relates to a wearable antenna device.

### BACKGROUND ART

In recent years, various types of radio communication services for outdoors such as a mobile telephone, a wireless Local Area Network (LAN), or a Worldwide Interoperability for Microwave Access (WiMAX) have become available. Further, voice transmission using a wireless microphone, a transceiver or the like, and wireless digital image transmission have become widespread, and frequency allocation management based on Radio Act has become important in order to efficiently use limited frequencies.

Further, news media around the world gather for large events such as sports events (Olympics, Paralympics, World Cup of various competitions etc.) and they transmit video data and voice data in real time using various radio communication devices. Therefore, different frequencies are allocated for each the news media around the world. In order to allow the news media of each country to perform smooth communication, it is desirable for the news media of each country to properly use the frequency allocated thereto.

Radio waves have been monitored in order to confirm that the frequency allocation is properly followed. It is required for radio wave monitoring antennas to have a wideband performance for monitoring radio waves having a wide range of frequencies. In addition, since a large-scale event venue is crowded with a large number of spectators and a large number of news media, there has been a growing need for wearable antenna devices capable of monitoring radio waves while a person wearing it is moving smoothly even in a crowded area. Patent Literature 1 discloses a configuration in which an antenna having a planar conductive sheet is mounted on or sewn to a garment such as a shirt. Patent Literature 2 discloses a configuration in which a planar-type antenna is attached to a garment such as a blazer or a jacket using surface fasteners or the like.

### CITATION LIST

### Patent Literature

### [Patent Literature 1] Japanese Unexamined Patent Application Publication No. 2010-200200

### [Patent Literature 2] Japanese Patent No. 5516422

### SUMMARY OF INVENTION

### Technical Problem

Wearable antenna devices are typically formed of planar-type antenna elements, not stereoscopic antenna elements. Planar-type antenna elements having a wideband performance include bow-tie antennas, spiral antennas and the like. However, both bow-tie antennas and spiral antennas have a wide directivity, the reception level of radio waves in a front direction that is orthogonal to a plane including an antenna element and that in the direction opposite to the front direction are equal to each other, and it is difficult to focus directivity only in a specific direction. This is disadvantageous when a radio wave radiating source is searched during the radio wave monitoring.

According to the configuration disclosed in Patent Literature 1, directivity due to currents in an upper side and a lower side of a curved line drawn by a peripheral edge shape of the planar conductive sheet can be adjusted. According to this structure, however, directivity in the direction that is orthogonal to the planar conductive sheet is not particularly taken into account. Further, in the configuration disclosed in Patent Literature 2 as well, directivity in the direction that is orthogonal to the planar-type antenna is not particularly taken into account.

In order to concentrate directivity of a planar-type antenna in a specific direction, it may be possible to arrange a reflector or a metal cavity in a position where their distance from the antenna element is about λ/4. The optimal position of the reflector or the cavity (optimal distance from the antenna element) varies depending on the frequency. In a case of an antenna that receives radio waves having a wide range of frequencies, when the reflector or the metal cavity is fixedly arranged in a specific position with respect to the antenna element, a problem that the antenna performance may be greatly degraded may occur due to an influence of the waves reflected from the reflector or the cavity depending on the frequency. In order to deal with this problem, a radio wave absorber may be attached to the reflector or the cavity to attenuate the reflected waves. However, when the reflector or the cavity is mounted on the antenna element and a radio wave absorber is further provided in the reflector or the cavity, the thickness of the wearable antenna device becomes large, which makes a user feel strange when this user wears the wearable antenna device. When the user wears, for example, a garment including the aforementioned wearable antenna device, the user feels uncomfortable, which is not preferable.

At least one of the objects of the present disclosure is to solve the aforementioned problem and to provide a wearable antenna device with high directivity while maintaining a small thickness thereof.

### Solution to Problem

A wearable antenna device according to the present disclosure includes an antenna part attached to a part of a garment including a body accommodation part that accommodates a part of a body, and a functional element arranged in a position of the garment in such a way that at least a part of the functional element is opposed to the antenna part with the body accommodation part interposed therebetween, in which the functional element is another antenna part or an element that performs at least one of reflection, shielding, and absorption of radio waves.

### Advantageous Effects of Invention

According to the present disclosure, it is possible to provide a wearable antenna device with high directivity while maintaining a small thickness thereof.

### BRIEF DESCRIPTION OF DRAWINGS

FIG. 1 is a cross-sectional view schematically showing a wearable antenna device according to a first example embodiment of the present disclosure;

FIG. 2A is an exploded view of a wearable antenna device according to a second example embodiment of the present disclosure;

FIG. 2B is a front view showing an inner side of a front body part of a garment of the wearable antenna device shown in FIG. 2A;

FIG. 2C is a front view showing an inner side of a back body part of the garment of the wearable antenna device shown in FIG. 2A;

FIG. 3 is an exploded view of the wearable antenna device shown in FIG. 2A;

FIG. 4 is an enlarged front view of a part of an antenna part of the wearable antenna device shown in FIG. 2A;

FIG. 5A is a front view of a power-feeding member attached to the antenna part shown in FIG. 4;

FIG. 5B is a back side view of the power-feeding member shown in FIG. 5A;

FIG. 6A is a front view showing an inner side of a front body part of a garment according to a modified example of the wearable antenna device according to the second example embodiment of the present disclosure;

FIG. 6B is a front view showing an antenna part of the wearable antenna device shown in FIG. 6A;

FIG. 6C is an enlarged front view of a part of the antenna part shown in FIG. 6B;

FIG. 7A is a front view showing an inner part of a front body part of a garment of a wearable antenna device according to a third example embodiment of the present disclosure;

FIG. 7B is an exploded view showing the wearable antenna device shown in FIG. 7A in a state in which an antenna part of the wearable antenna device is detached;

FIG. 7C is a front view showing an inner side of a front body part of a garment according to a modified example of the wearable antenna device according to the third example embodiment of the present disclosure;

FIG. 8A is an exploded view of a wearable antenna according to a fourth example embodiment of the present disclosure in a state in which an antenna part of the wearable antenna device is detached;

FIG. 8B is a front view of an antenna part of the wearable antenna device according to the fourth example embodiment of the present disclosure;

FIG. 8C is a front view showing an antenna part according to a modified example of the wearable antenna device according to the fourth example embodiment of the present disclosure;

FIG. 9A is an exploded view of a wearable antenna device according to a fifth example embodiment of the present disclosure in a state in which an antenna part of the wearable antenna device is detached;

FIG. 9B is a front view of an antenna part of the wearable antenna device according to the fifth example embodiment of the present disclosure;

FIG. 9C is a front view showing an antenna part according to a modified example of the wearable antenna device according to the fifth example embodiment of the present disclosure;

FIG. 10A is an exploded perspective view of a wearable antenna device according to a sixth example embodiment of the present disclosure;

FIG. 10B is a perspective view of the wearable antenna device shown in FIG. 10A; and

FIG. 11 is a cross-sectional view schematically showing a wearable antenna device according to a seventh example embodiment of the present disclosure.

### DESCRIPTION OF EMBODIMENTS

In the following description, example embodiments of the present disclosure will be explained.

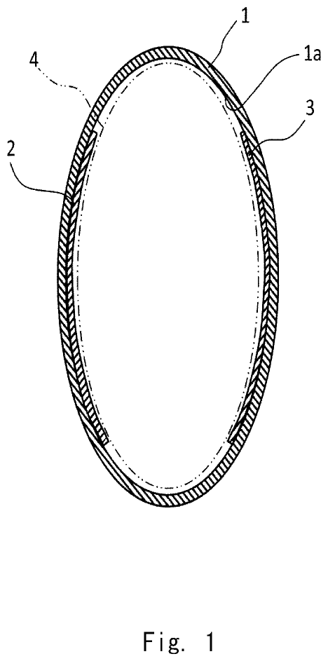

A wearable antenna device according to a first example embodiment of the present disclosure that is schematically shown in FIG. 1 includes an antenna part 2 and a functional element 3 in a garment 1 including a body accommodation part 1a that accommodates a part of a body 4 (schematically shown in FIG. 1 by an alternate long and two short dashes line). Specifically, the antenna part 2 is arranged in a part of the garment 1, and the functional element 3 is arranged in a position of the garment 1 in such a way that at least a part of the functional element 3 is opposed to the antenna part 2 with the body accommodation part 1a interposed therebetween. Accordingly, at least a part of the antenna part 2 and at least a part of the functional element 3 are opposed to each other via the body accommodation part 1a. While the side of the antenna part 2 with respect to the body accommodation part 1a is referred to as a front side and the direction that is opposite to the antenna part 2 is referred to as a rear side for the sake of convenience in this example, they may not coincide with the front side (abdominal side) and the rear side (back side) of the human body when he/she wears a garment.

According to the configuration of this example embodiment, the body part 4 accommodated (inserted) in the body accommodation part 1a located between the antenna part 2 and the functional element 3 functions as a dielectric having frequency characteristics. Specifically, water in the body, which is the main component of the body 4, especially absorbs or attenuates the radio waves.

Further, when the functional element 3 is an element that performs at least one of reflection, absorption, and shielding of radio waves, the radio waves coming from the direction in which the functional element 3 is located are reflected, absorbed, or shielded by the functional element 3, and are absorbed or attenuated by the body 4 positioned between the functional element 3 and the antenna part 2. Accordingly, the amount of radio waves that reach the antenna part 2 is reduced. As a result, when the antenna part 2 receives the radio waves, the reception level of the radio waves coming from the front side of the antenna part 2 becomes high and the reception level of the radio waves coming from the side of the functional element 3 and the body 4 becomes low, and the difference in the reception level between the both directions becomes large. Accordingly, high directivity reception in the antenna part 2 can be achieved. This point is extremely effective when the antenna part 2 is used as, for example, a radio wave receiving antenna for monitoring radio waves to search for a source of illegal radio waves.

When the antenna part 2 emits radio waves, the radio waves that travel from the antenna part 2 toward the functional element 3 and the body 4 are absorbed or attenuated by the body 4 and are reflected, absorbed, or shielded by the functional element 3, similar to the example stated above. Therefore, the level of the radio waves that travel from the antenna part 2 toward the functional element 3 and the body 4 becomes low. As a result, the level of the radio waves emitted from the antenna part 2 to the front side becomes high and the level of the radio waves that travel toward the functional element 3 and the body 4 becomes low, and the difference in the level between the both directions becomes large. Accordingly, high directivity transmission in the antenna part 2 is achieved. As described above, high directivity can be achieved in this example embodiment in both the reception and the transmission of the radio waves using the antenna part 2.

When, in particular, the functional element 3 is a reflective element, the radio waves that have come from the front side of the antenna part 2 and have reached the functional element 3 are reflected by the functional element 3 and the reflected radio waves are made to travel toward the antenna part 2 again. Therefore, it is possible that the reception level or the radiation level of the radio waves in the antenna part 2 may become higher. However, if the radio waves reflected by the functional element 3 may possibly adversely affect the performance of the antenna part 2, the functional element 3 having a function of shielding or absorption, not a function of reflection, is preferably provided.

Further, when the functional element 3 is an element that functions as another antenna part as well, it is efficient that the body 4 positioned between the antenna part 2 and the functional element 3 function as a dielectric and absorb or attenuate the radio waves. That is, when radio waves are emitted from the antenna part 2, the radio waves propagate toward the front side at a high level, whereas the radio waves propagate toward the functional element 3 at a low level since the radio waves are absorbed or attenuated by the body 4. Accordingly, radio waves emitted from the antenna part 2 on the front side do not have a large influence on the reception and the transmission of radio waves in the functional element 3 that functions as another antenna part. That is, when the functional element 3 transmits radio waves as another antenna part, the radio waves coming from the side of the antenna part 2 (front side) are absorbed or attenuated by the body 4, and therefore radio waves hardly ever reach the functional element 3. As a result, the functional element 3 can emit radio waves to a side opposite to the antenna part 2 without being influenced by the radio waves from the antenna part 2. On the other hand, the radio waves emitted from the functional element 3 and propagating toward the antenna part 2 (front side) are also absorbed or attenuated by the body 4. As a result, the functional element 3 can transmit radio waves with high directivity, similar to the antenna part 2.

When the functional element 3 receives radio waves as another antenna part, radio waves coming from the antenna part 2 hardly ever reach the functional element 3 since they are absorbed or attenuated by the body 4. As a result, in the functional element 3 that functions as the antenna part, high directivity in which the reception level of the radio waves coming from the side opposite to the antenna part 2 is high and the reception level of the radio waves coming from the side of the antenna part 2 (front side) is high is achieved. When the antenna part 2 receives radio waves and the functional element 3 transmits radio waves, the antenna part 2 is able to perform reception with high directivity, and the functional element 3 is able to perform transmission with high directivity. This can be understood by switching the antenna part 2 and the functional element 3 in the above description.

When both the antenna part 2 and the functional element 3 receive radio waves, the both elements may perform reception with high directivity. This is because, since at least a part of the antenna part 2 and the functional element 3 are opposed to each other with the body accommodation part 1a and the body 4 interposed therebetween, the radio waves from the side of the functional element 3 are absorbed or attenuated by the body 4 with respect to the antenna part 2, and the radio waves from the side of the antenna part 2 are absorbed or attenuated by the body 4 with respect to the functional element 3.

As described above, in this example embodiment, transmission and reception of radio waves with high directivity can be performed in the antenna part 2 mainly due to the effect of the body 4, which serves as a dielectric. Since the directivity is high, the influence that the radio waves coming from an undesirable direction have on the antenna part 2 is small, and further undesirable influences on another member that are due to the radio waves from the antenna part 2 are small. Therefore, it becomes possible to increase the size of the antenna part 2. Accordingly, a wearable antenna device with high performance can be formed. When the functional element 3, at least a part of which being opposed to the antenna part 2 with the body accommodation part 1a interposed therebetween, is an element that reflects, absorbs, or shields the radio waves, directivity of transmission and reception of radio waves in the antenna part 2 is further improved and the size of the antenna part 2 can be further increased and the performance thereof can be further improved. On the other hand, when the functional element 3 is an element that functions as another antenna part, the functional element 3 as well as the antenna part 2 are able to perform transmission and reception of radio waves with high directivity mainly due to the effect of the body 4, which serves as a dielectric, whereby it is possible to increase the size of the functional element 3 and to improve the performance thereof. As described above, regardless of whether the antenna part 2 performs transmission or reception, or regardless of whether the functional element 3 performs reflection, absorption, or shielding of radio waves or functions as another antenna part, this example embodiment contributes to improving directivity. Further, the antenna part 2 and electric systems connected thereto are designed considering the frequency characteristics of the body 4 in advance, whereby the body 4 can be efficiently used as a dielectric and further the wearable antenna device having an appropriate performance (in accordance with a required specification) can be easily formed in accordance with actual usage conditions.

In the example shown in FIG. 1, substantially the whole part of the antenna part 2 and the functional element 3 are opposed to each other with the body accommodation part 1a interposed therebetween. Alternatively, only a part of the antenna part 2 and a part of the functional element 3 may be opposed to each other with the body accommodation part 1a interposed therebetween. That is, the antenna part may be attached to a part of the garment and the functional element 3 may be arranged in a position of the garment in such a way that at least a part of the functional element 3 is opposed to the antenna part with the body accommodation part interposed therebetween. This configuration is also within the range of the present disclosure since the body 4 accommodated in the body accommodation part 1a absorbs or attenuates the radio waves, which causes at least a certain effect of improving the directivity of transmission and reception of radio waves in the antenna part 2.

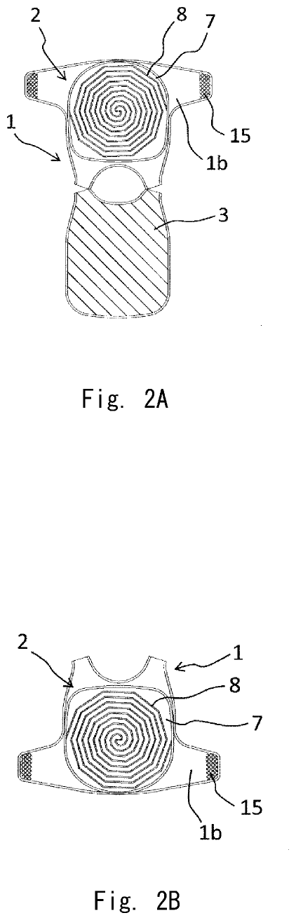

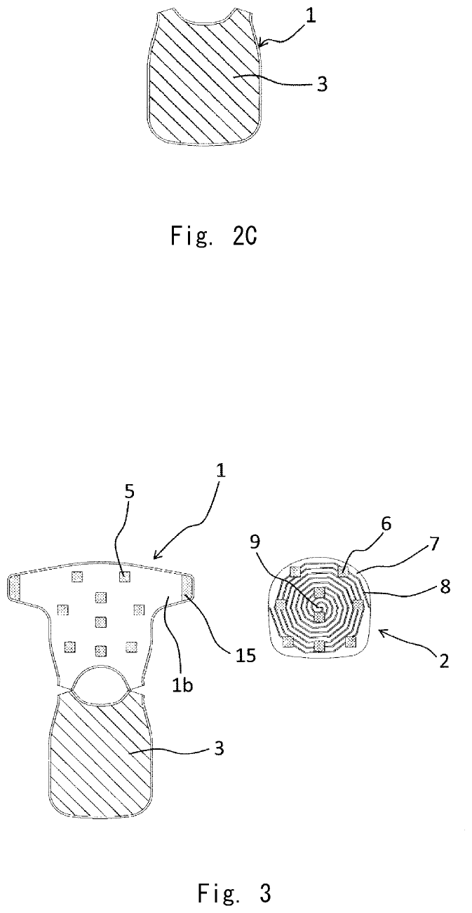

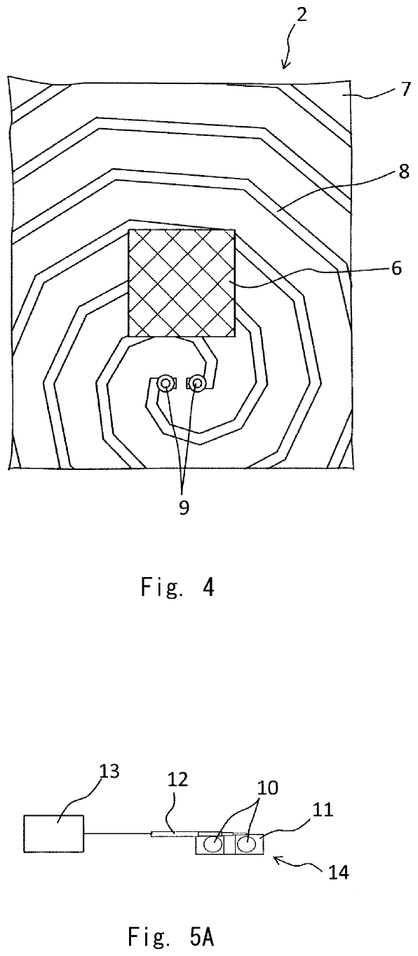

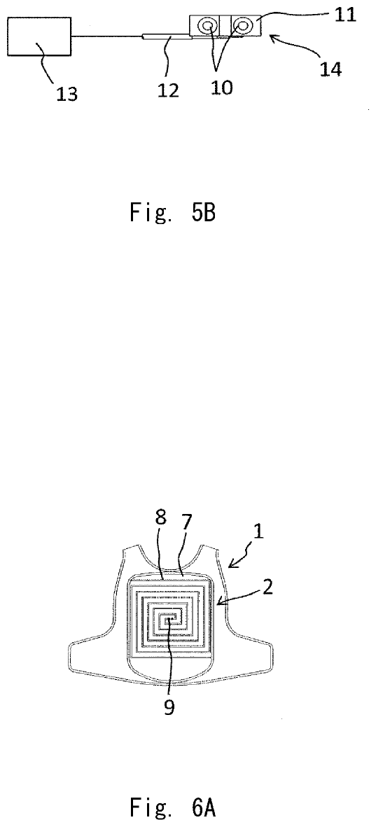

In the following description, example embodiments of the wearable antenna device according to the present disclosure will be explained in further detail. FIG. 2A is an exploded view of a wearable antenna device according to a second example embodiment of the present disclosure. FIG. 2B is a front view showing an inner side of a front body part of a garment of the wearable antenna device. FIG. 2C is a front view showing an inner side of a back body part of the garment of the wearable antenna device. FIG. 3 is an exploded view of the wearable antenna device, and FIG. 4 is an enlarged front view of a part of the antenna part of the wearable antenna device. FIGS. 5A and 5B are a front view and a back side view of a power-feeding member attached to the antenna part, respectively.

In this example embodiment, the wearable antenna device includes, similar to that in the aforementioned first example embodiment, the antenna part 2 arranged in a part of the garment 1, and the functional element 3 arranged in a position of the garment 1 in such a way that at least a part of the functional element 3 is opposed to the antenna part 2 with the body accommodation part 1a interposed therebetween. In this example embodiment, a vest is used as the garment 1 in the wearable antenna device. Then, the antenna part 2 is arranged in the front body part of the vest 1, and the functional element 3 is arranged in the back body part. More specifically, as shown in FIG. 3, surface fasteners 5 are attached to the inner side of the front body part of the vest 1 (side that is close to the body 4). As shown in FIGS. 2A and 2B, the antenna part 2 includes a planar-type antenna element 8 such as a spiral antenna formed on a sheet-like base 7 having flexibility. As one example, a spiral antenna having a spiral shape made of a conductive thread, cloth, ink, and/or film is formed on a thin insulating base 7 made of cloth or resin. Further, surface fasteners 6 are attached to the positions of the base 7 opposed to the surface fasteners 5 of the vest 1, as shown in FIGS. 3 and 4, although they are omitted in FIGS. 2A and 2B. The surface fasteners 6 may be formed in such a way that they do not overlap the antenna element 8, or may be formed in such a way that they overlap the antenna element 8. By bonding together the surface fasteners 5 and the surface fasteners 6 shown in FIG. 3, the antenna part 2 can be mounted on the inner side of the front body part of the vest 1 (side that is close to the body 4). On the other hand, as shown in FIGS. 2A, 2C, and 3, the functional element 3 is arranged on the inner side of the back body part of the vest 1. The antenna part 2 and the functional element 3 may be formed in a similar method. Each of the antenna part 2 and the functional element 3 may be, for example, directly formed in the garment 1 using a conductive thread, cloth, ink, film or the like, or may be indirectly attached to the garment 1. As one example, the functional element 3 can be formed by attaching a sheet made of a conductive material to the back body part of the vest 1 or applying a conductive ink to the back body part of the vest 1. The functional element 3 may have a configuration in which a conductive material is formed for the entire surface as shown in the drawings, a configuration in which a conductive material is patterned, for example, in a mesh shape, or a configuration in which a conductive material is formed to have another desired shape.

In this example embodiment, as shown in FIG. 4, snap buttons for power feeding 9 are provided in a part of the antenna element 8 (in the example shown in FIG. 4, the innermost peripheral end of the spiral antenna). A power-feeding member 14 shown in FIGS. 5A and 5B is attached to these snap buttons for power feeding 9. Specifically, a coaxial cable 12 is connected to a printed board 11 including snap buttons for power feeding 10 that correspond to the snap buttons for power feeding 9, and the coaxial cable 12 is further connected to an electronic device 13 such as a spectrum analyzer, thereby forming the power-feeding member 14. The snap buttons for power feeding 10 of this power-feeding member 14 are fitted into the snap buttons for power feeding 9 of the antenna part 2, whereby the electronic device 13 is connected to the antenna element 8. Accordingly, the radio waves received by the antenna part 2 can be analyzed by the electronic device 13, or necessary radio waves can be emitted from the antenna part 2 in accordance with a command from the electronic device 13. When the functional element 3 is an element that is used as another antenna part, similar snap buttons for power feeding or power-feeding member may be provided to form a power-feeding mechanism for the functional element 3, although it is not shown.

In this example embodiment, the antenna part 2 and the functional element 3 are mounted on the inner side of the vest 1 (side that is close to the body 4, rear surface), and are located closer to the body accommodated in the body accommodation part 1a than a case in which they are mounted on the outer side (front surface). Further, the vest 1 according to this example embodiment can be fixed in a state in which it closely contacts the body 4 of the user using surface fasteners 15 provided in a side belt part 1b located in the waist part. In this configuration, when the antenna part 2 and the functional element 3 closely contact the body 4 and are held, there is no gap in which radio waves sneak into a part between the antenna part 2 and the functional element 3, and the body 4 that functions as a dielectric. That is, it is possible to maintain a state in which the antenna part 2 and the functional element 3 are electrically separated from each other as much as possible. Accordingly, the antenna part 2 and the functional element 3 can each function independently from each other, and therefore it is highly likely that the effect such as improvement in directivity described above can be obtained. Further, it is possible to increase the size of the antenna part 2 and that of the functional element 3 without much concerning about the possibility that the antenna part 2 and the functional element 3 end up to be electrically connected to each other due to the sneaked radio waves. This greatly contributes to improving the performance of the antenna part 2 and the functional element 3. However, even when the antenna part 2 and the functional element 3 are mounted on the inner side of the vest 1 (the side of the body 4, rear surface), the antenna part 2 and the functional element 3 are each covered with a shirt or a cloth (not shown) in order to prevent the antenna element 8 from directly contacting the body 4 and from being electrically conducted. In this example embodiment, the antenna part 2 and the functional element 3 may be mounted on the outer side (front surface) of the garment (e.g., the vest 1) considering the design and the functionality of the garment. Further, it is possible that the antenna part 2 and the functional element 3 may be held in a state in which they do not closely contact the body 4. Even in this case, the configuration according to this example embodiment is efficient to improve directivity of transmission and reception of radio waves as described above, and to obtain the effects in accordance therewith.

Further, in this example embodiment, the antenna part 2 is arranged on the front surface side (front side, abdominal side) of the human body when the user wears the garment (vest) 1, and the functional element 3 is arranged on the opposite side thereof, that is, the back surface side (rear side, back side). According to this structure, directivity focuses on the front side of the human body, that is, in the front of the line of sight of the user who wears the vest 1, whereby it becomes extremely easy to search for, for example, a source of radio waves when illegal radio waves are received.

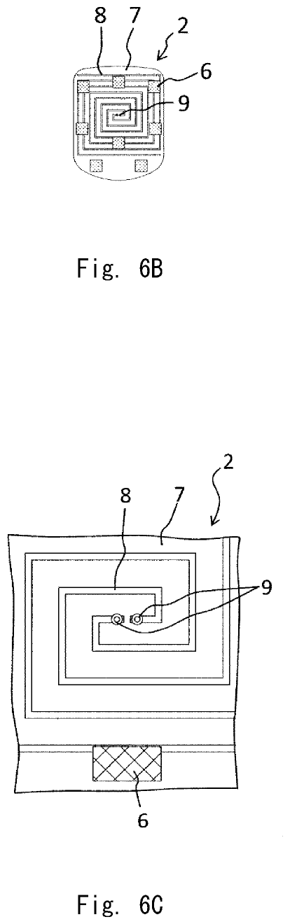

FIGS. 6A to 6C are diagrams showing modified examples of this example embodiment. In these modified examples, the antenna element 8 is a rectangular spiral antenna, not a spiral antenna having a circular shape or a substantially circular shape. As described above, the antenna element 8 of various shapes may be used, and a planar-type antenna element of various forms other than a spiral antenna can be used as well. Since the other configurations are similar to those shown in FIGS. 2A-5B, descriptions thereof will be omitted.

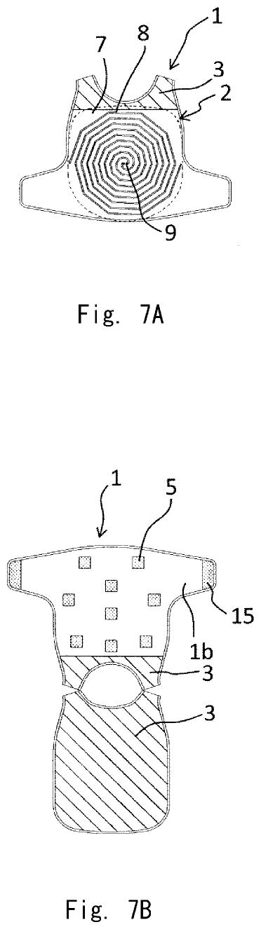

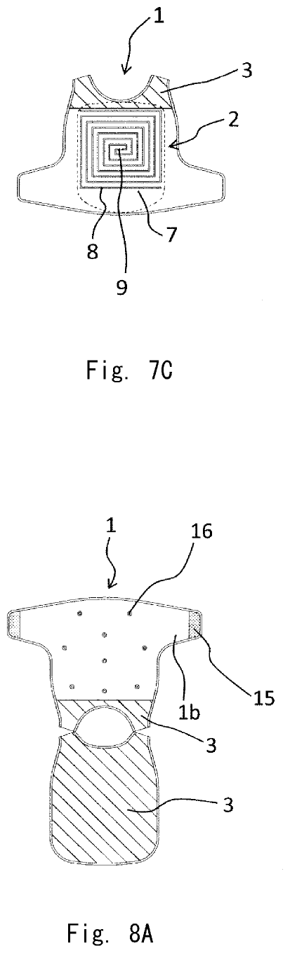

FIGS. 7A and 7B are diagrams showing a third example embodiment of the wearable antenna device according to the present disclosure. In this example embodiment, the functional element 3 is formed to have a large area, that is, it is formed not only on the rear side (back side) of the vest 1 but also on the front surface of the shoulder part. While the back body part and the front body part of the vest 1 are separated from each other in the exploded view shown in FIG. 7B etc. for the sake of explanation, they are actually formed continuously, and the functional element 3 located on the whole surface of the back body part and the functional element 3 located in the shoulder part of the front body part are continuously formed. According to this structure, the size of the functional element 3 becomes large, and therefore the function thereof is improved. Accordingly, the functional element 3 having a large area contributes to a further improvement in the directivity in the antenna part 2, and the performance of the functional element 3 itself when the functional element 3 functions as another antenna part can be improved. Since the other configurations are similar to those shown in the first example embodiment, descriptions thereof will be omitted. As shown in a modified example shown in FIG. 7C, the antenna element 8 according to this example embodiment may also be a planar-type antenna element of various forms such as a rectangular spiral antenna.

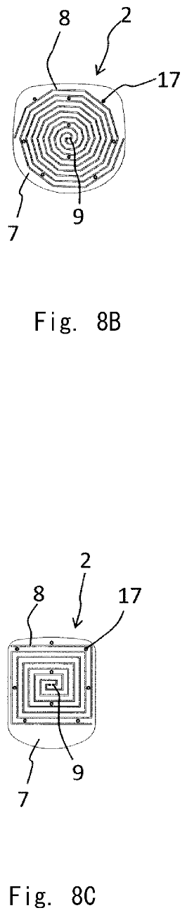

FIGS. 8A and 8B are diagrams showing a fourth example embodiment of the wearable antenna device according to the present disclosure. In this example embodiment, similar to that in the third example embodiment, the functional element 3 is formed to have a large area, that is, it is formed not only on the rear side (back side) of the vest 1 but also on the front surface of the shoulder part. Further, in this example embodiment, the antenna part 2 is attached to the vest 1 using snap buttons 16 and 17 instead of using surface fasteners 5 and 6. With this structure as well, the antenna part 2 can be easily attached to the vest 1. As shown in a modified example shown in FIG. 8C, in this example embodiment as well, a planar-type antenna element 8 of various forms such as a rectangular spiral antenna can be used.

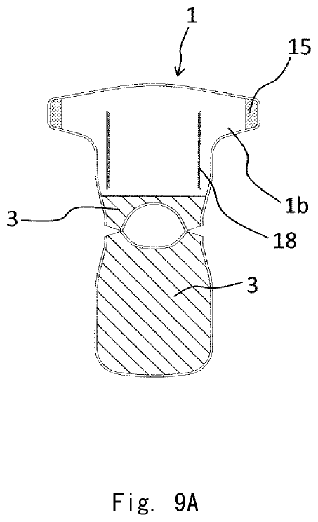

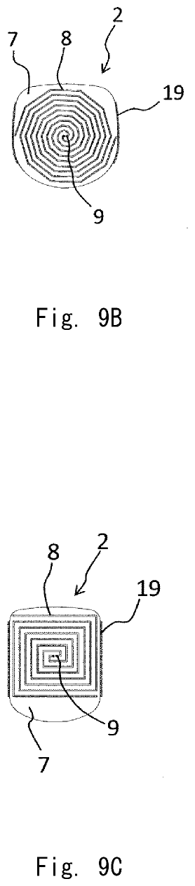

FIGS. 9A and 9B are diagrams showing a fifth example embodiment of the wearable antenna device according to the present disclosure. In this example embodiment, similar to those in the third and fourth example embodiments, the functional element 3 is formed to have a large area, that is, it is formed not only on the rear side (back side) of the vest 1 but also on the front surface of the shoulder part. Further, in this example embodiment, the antenna part 2 is attached to the vest 1 using fasteners 18 and 19 instead of using the surface fasteners 5 and 6 or the snap buttons 16 and 17. With this structure as well, the antenna part 2 can be easily attached to the vest 1. As shown in a modified example shown in FIG. 9C, in this example embodiment as well, a planar-type antenna element 8 of various forms such as a rectangular spiral antenna can be used.

The antenna part 2 can be attached to the garment 1 using the surface fasteners 5 and 6, the snap buttons 16 and 17, and the fasteners 18 and 19 according to the first to fifth example embodiments, or various attachment/detachment mechanisms for garments such as buttons (not shown). All of these attachment/detachment mechanisms for garments are generally available easily for a low cost, and work of attaching them, and attaching and detaching work of the antenna part 2 using them may be performed extremely easily. The attachment/detachment mechanism to be actually used can be determined by a user as appropriate. Further, the functional element 3 may be also attached to the garment 1 using a similar attachment/detachment mechanism for a garment.

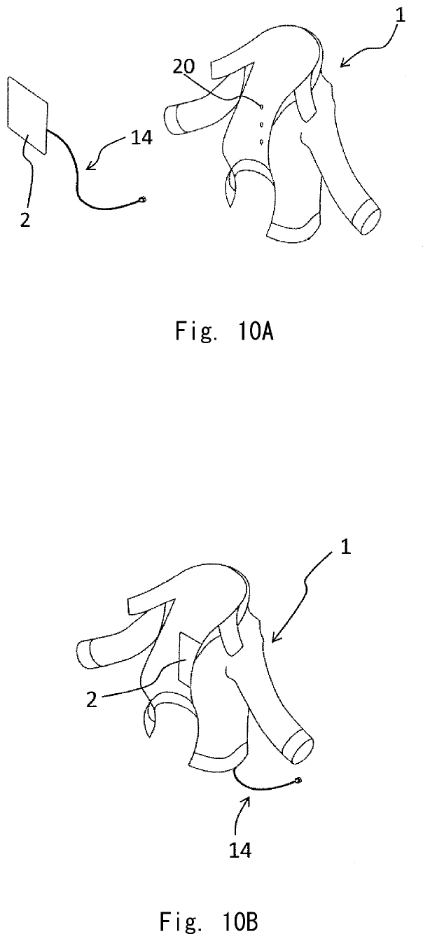

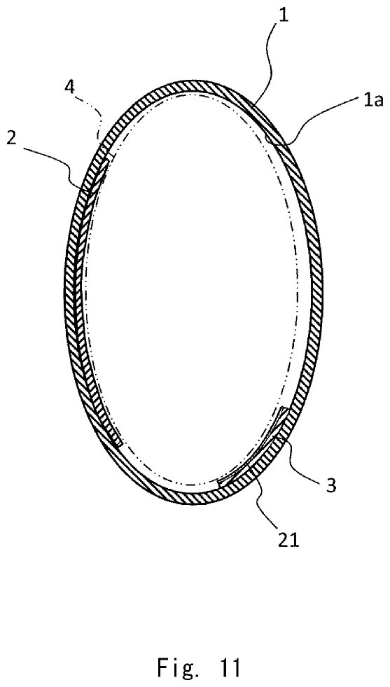

FIGS. 10A and 10B are diagrams showing a sixth example embodiment of the wearable antenna device according to the present disclosure. In this example embodiment, an overcoat, not a vest, is used as the garment 1, and the antenna part 2 is attached to the inner side of the back part (back side) of the overcoat 1 using snap buttons 20. According to this structure, it is possible to hold the power-feeding member 14 and the electronic device (omitted in FIGS. 10A and 10B) connected thereto without exposing them to the front side. Further, a functional element may be provided in the front part (abdominal side). As described above, the position of the antenna part 2 can be changed in accordance with the design and the functionality of the garment 1. Further, the garment is not limited to the vest described in the second to fifth example embodiments or the overcoat described in the sixth example embodiment, and the wearable antenna device according to the present disclosure may be formed using a variety of garments. Further, in accordance with the design and the function of the garment, any part of the body such as an abdominal part, a chest part, a shoulder part, a back part, a waist part, a hip part, an arm part, a leg part, a neck part, a head part, or a finger part may be used as a dielectric to form the wearable antenna device according to the present disclosure. That is, regardless of the part of the body 4 interposed between the antenna part 2 and the functional element 3, at least a part of which being opposed to each other, the effects of the present disclosure described above (e.g., improvement in the directivity in the antenna part 2) can be obtained.

A seventh example embodiment of the wearable antenna device according to the present disclosure schematically shown in FIG. 11 has a configuration in which only a part of the functional element 3 is opposed to the antenna part 2 with the body accommodation part 1a interposed therebetween. With this configuration as well, effects of the present disclosure described above (e.g., improvement in directivity in the antenna part) can be obtained to some extent. Further, in this example embodiment, a radio wave absorber 21 is provided in the functional element 3. This configuration further improves the function in which the functional element 3 absorbs the radio waves, and allows the wearable antenna device in accordance with a required specification to be easily formed.

In the present disclosure, the body accommodation part 1a that accommodates a part of the body is arranged between the antenna part 2 and the functional element 3, and the body 4 accommodated in the body accommodation part 1a functions as a dielectric having specific frequency characteristics. In the present disclosure, the wearable antenna device is designed so as to obtain a desired performance the function of the body 4 as the dielectric, namely absorption or attenuation of radio waves by water, which is a main component of the body 4. Further, directivity of reception and transmission of radio waves in the antenna part 2 is improved by the function as the dielectric of the body 4, whereby the excellent function and performance are achieved as, for example, a wearable antenna device used for monitoring radio waves.

In the present disclosure, some of the configurations in the aforementioned first to seventh example embodiments may be combined as appropriate.

While the present disclosure has been explained above with reference to the example embodiments, the present disclosure is not limited to them. Various changes that may be understood by one skilled in the art can be made to the configuration and the details of the present disclosure within the scope of the present disclosure.

This application is based upon and claims the benefit of priority from Japanese Patent Application No. 2017-091928, filed on May 2, 2017, the disclosure of which is incorporated herein in its entirety by reference.

### REFERENCE SIGNS LIST

1 GARMENT
1A BODY ACCOMMODATION PART
1B SIDE BELT PART
2 ANTENNA PART
3 FUNCTIONAL ELEMENT
4 BODY
5, 6 SURFACE FASTENER
7 BASE
8 ANTENNA ELEMENT
15 SURFACE FASTENER (ATTACHMENT/DETACHMENT MECHANISM FOR GARMENT)
16, 17 SNAP BUTTON (ATTACHMENT/DETACHMENT MECHANISM FOR GARMENT)
18, 19 FASTENER (ATTACHMENT/DETACHMENT MECHANISM FOR GARMENT)
20 SNAP BUTTON (ATTACHMENT/DETACHMENT MECHANISM FOR GARMENT)
21 RADIO WAVE ABSORBER

1. A wearable antenna device comprising an antenna part attached to a part of a garment including a body accommodation part configured to accommodate a part of a body, and a functional element arranged in a position of the garment in such a way that at least a part of the functional element is opposed to the antenna part with the body accommodation part interposed therebetween, wherein the functional element is another antenna part or an element configured to perform at least one of reflection, shielding, and absorption of radio waves.

2. The wearable antenna device according to claim 1, wherein one of the antenna part and the functional element is arranged on a front surface side of the garment and the other one of the antenna part and the functional element is arranged on a back surface side of the garment.

3. The wearable antenna device according to claim 1, wherein the antenna part and the functional element are arranged on an inner side, which is a side of the garment that is close to the body.

4. The wearable antenna device according to claim 1, wherein the antenna part and the functional element are arranged in such a way that they closely contact the body accommodated in the body accommodation part.

5. The wearable antenna device according to claim 1, wherein the antenna part and the functional element each include at least one of a conductive thread, cloth, ink, and film, and have flexibility.

6. The wearable antenna device according to claim 1, comprising an attachment/detachment mechanism for a garment configured to attach one or both of the antenna part and the functional element to the garment, wherein the attachment/detachment mechanism for the garment includes at least one of a surface fastener, a fastener, a button, and a snap button.

7. The wearable antenna device according to claim 1, wherein the functional element is an element configured to perform at least one of reflection, shielding, and absorption of radio waves, and a radio wave absorber is provided in the functional element.
